(19) United States
(12) Patent Application Publication
(10) Pub. No.: US 2009/0313848 A1
(43) Pub. Date: Dec. 24, 2009

(54) METHOD AND HOUSEHOLD APPLIANCE FOR DRYING WET LAUDRY

(75) Inventors: Harald Moschütz, Grossbeeren (DE); Ulrich Nehring, Berlin (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, Munchen (DE)

(21) Appl. No.: 12/309,995

(22) PCT Filed: Jul. 11, 2007
(86) PCT No.: PCT/EP2007/057096

§ 371 Date: Feb. 6, 2009

(30) Foreign Application Priority Data
Aug. 9, 2006 (DE) 10 2006 037 239.5

(51) Int. Cl. F26B 19/00; G05D 23/00; D06F 58/04

(52) U.S. Cl. 34/549; 700/299; 34/132; 34/572

(57) ABSTRACT

A household appliance for drying damp laundry that includes a heating device that generates warm air, a laundry drum for accommodating laundry, a motor for driving the laundry drum, a measuring device that measures a dampness value or a measured value of the laundry, a temperature measuring device that determines a temperature variable in response to a predetermined dampness value or a measured value of the laundry being reached, and a controller for controlling the heating device and the motor, for analyzing the dampness value or the measured value of the laundry, and for terminating drying based upon the temperature variable corresponding to a respective laundry type or a respective state of loading of the laundry drum.

The present invention relates to a method for controlling the drying of damp laundry in a laundry drum of a household appliance for drying damp laundry, in which warm air is generated and in which a drying process is terminated, taking into account at least one dampness value or a measured value of the laundry to be dried which corresponds thereto.

The invention also relates to a household appliance for drying damp laundry, in particular to a tumble dryer or washer dryer, for controlling the drying of damp laundry by means of warm air generated by a heating device, comprising a laundry drum accommodating the laundry, which laundry drum can be driven by a motor which, together with the said heating device, can be controlled by a control device, and comprising at least one measuring device, which measures at least one dampness value or a measured value of the laundry to be dried corresponding thereto, for analysis and termination of the respective drying process by the control device.

A washer dryer is in the present case understood to mean a corresponding household appliance in which laundry can be washed and e.g. subsequently dried; a dryer is understood to mean a corresponding household appliance in which damp laundry can only be dried.

To control a household appliance for drying damp laundry as a function of the dampness of the laundry, a current-carrying measuring device in a laundry drum or washing drum (see e.g. DE 36 42 459 C3) is commonly used. In the laundry drum or washing drum concerned, the measuring device mentioned comes into contact with the laundry to be dried. Use is made of the fact that the ohmic resistance in the measuring device is inversely proportional to the dampness of the laundry. Where the dampness level is high after washing and spinning, the laundry has a resistance of a few ohms, but in the dry state, on the other hand, the resistance is as high as several megohms. By means of a program controller, a voltage value corresponding to the respective resistance can be compared as an actual voltage value against a predetermined voltage setpoint value, and if the voltage setpoint value is exceeded by the actual voltage value, the drying process can be terminated.

An attempt has also been made to use the temperature of the exhaust air which emerges from the laundry drum after passing through the laundry as an auxiliary variable for terminating the drying program. Here, the effect is exploited that as laundry becomes increasingly dry less thermal energy is used for evaporating the water contained in the laundry and the temperature of the air at the laundry drum outlet therefore rises. However, this method is not precise enough to meet the high demands which now exist in terms of the cut-off accuracy of household dryers.

A method for controlling drying processes in a household appliance for drying damp laundry (DE 44 47 270 A1) is also known which at the start time of a drying process measures the exhaust-air temperature at an exhaust-air outlet. During at least one time segment at the start of the drying process, a part of or the whole of heating device is periodically switched on and off. After the start phase, the duration of which is measured by the timespan of from one to three heating periods, is complete, air-temperature measurements are carried out at the inlet of the heating device upstream of a supply-air inlet and immediately downstream of the exhaust-air outlet, and from the measured values of the exhaust air, at the inlet of the heating device and of the supply air, differences are formed and stored. In addition, process variables, such as the time which has actually expired since the program start, temperature values and dampness values of the laundry to be dried, are constantly or at least periodically measured several times a second. When predetermined limit values are reached, as a function of input program parameters relating to the laundry type, quantity and/or initial residual moisture, in each case a call of several stored process sequences is issued to the storage unit for outputting to the program controller and for processing. Although the drying time of laundry required in each case can be determined relatively well using this known method, the large number of process steps is occasionally considered undesirable.

A method is also known for changing the program sequence in a household appliance for drying damp laundry (DE 102 00 975 C2), in which moisture sensors are fitted to lateral grids guided between a door and a laundry drum at a height above the lowest point of the laundry drum. The time intervals between the individual contacts with set minimum dampness are recorded by means of the moisture sensors and from these statistical mean values are formed. These moisture sensors serve to measure an ohmic resistance which the laundry to be dried possesses when it contacts these sensors. From the statistical mean values of the time intervals determined in this manner, changes in the program parameters, display of the residual drying time and termination of the drying process are determined. This known method has, however, the disadvantage that overall the reliability of control of the drying process from the measured residual moisture values alone is too low.

A first reason for this problem is that, depending on the respective laundry type, measurement errors can arise during the drying process. In such cases, the respective measured value may reach a preset target value significantly earlier than expected and thereby cause the process to be interrupted with an excessively high laundry dampness level. An example of such an unfavorable case is presented by e.g. the drying of lined anoraks. In this case, the synthetic fiber of the anorak may dry very quickly and, when the resistance is measured, bring about the delivery of a signal to terminate the drying process, even though the interior of the anorak is still damp.

A second reason is given by the fact that, if the laundry drum has a very low load, a poor contact may prevail between the items of laundry located therein and the moisture sensors projecting into the laundry drum to measure the laundry resistance and incorrect values may then be passed to the associated controller.

A third reason is that the residual moisture in the laundry tends to change slowly when the drying process is at the advanced stage. For this reason alone, subject to given production and measurement tolerances in respect of the moisture sensors, only a relatively imprecise estimation of the progress of the drying process is possible by analyzing the residual moisture values. In particular, a limit value for terminating the drying process can be defined only with an adequate safety margin, which leads to a certain prolongation of the drying process beyond the extent necessary. In the case of quick-drying types of laundry, this method can also cause unwanted overdrying of laundry.

The object of the invention is therefore to show a way how in a relatively simple manner and at relatively low cost in a method and a household appliance for drying damp laundry of the type specified in the introduction a switching off of the household appliance after execution of the respective drying process can be provided at the correct time desired in each case, while avoiding any over or underdrying of the laundry as a function of the respective laundry type and/or quantity. In relation to the in connection with the last examined cases of laundry to be dried in a drum, this means that on the one hand e.g. lined anoraks will be dried until such time as the respective anorak lining is free of moisture and that on the other if the laundry drum has a low load no overdrying of the laundry accommodated by this will take place, i.e. overdrying will be avoided.

The object shown above is achieved according to the invention in a method of the type specified in the introduction firstly in that a temperature variable which is determined during drying of the laundry when or after a predetermined dampness value or a measured value corresponding thereto is reached, and which corresponds to the respective laundry type and/or the respective state of loading of the laundry drum is additionally used for the targeted termination of the drying.

The invention brings with it the advantage that it is ensured in a particularly simple manner that over- or underdrying as a function of the respective laundry type and quantity is avoided and that the respective drying process can be terminated at the correct time desired in each case, i.e. when the laundry concerned has been dried in the desired manner. This is achieved in that the mentioned temperature variable is additionally used in correlation with a defined dampness value or a measured value corresponding thereto.

The invention is based on the realization that the temperature of the exhaust air flowing out of the laundry drum exhibits, after an initial rise caused by the heating up of the laundry and of the appliance itself, only a slight change over the course of the drying process and rises again significantly toward the end of the drying process. It is assumed here that the temperature of the supply air which flows into the laundry drum is held broadly constant, in accordance also with common practice. In a case where such constancy is not given, what has been said applies to the difference between the temperatures of the supply air and the exhaust air. The slight change of temperature of the exhaust air and the difference over large parts of the drying process is due to the fact that a flow equilibrium forms in which the moisture from the surface of the fibers of the laundry to be dried evaporates and is removed with the exhaust air.

When the drying process is sufficiently far advanced and the overwhelming majority of the moisture has been removed from the laundry, then there is no longer sufficient moisture lying on the surface of the laundry to be dried which could be evaporated and this leads to evaporation of the moisture inside the fibers. The flow equilibrium is disrupted by this; the evaporation of moisture inside the fibers requires a higher temperature, which ultimately leads to a significant increase in the temperature of the exhaust air and a reduction of the difference. It has been recognized according to the invention that this temperature increase takes place more or less when the moisture in the laundry has been removed except for a residual moisture corresponding to a normally desired degree of drying, and this temperature increase can therefore be used as a good indicator for terminating the drying process.

A useful further development of the invention consists in evaluating the absolute values of the drying temperature. This brings with it the advantage of a particularly simple measurement.

For example, the temperature of the exhaust air at the drum outlet of the dryer can be measured, preferably periodically, from the start of the drying phase. Here, fluctuations in the heating, the mains voltage, the loading of the laundry drum, the ambient temperature and the state of maintenance of the appliance are advantageously also taken into account.

According to another useful embodiment of the invention, the gradient of the drying temperature curve is evaluated. In this way, the advantage is achieved that the state of dryness of the laundry in the laundry drum can be recorded even more precisely.

The temperature changes of the exhaust air are preferably recorded at the drum outlet and the associated measured values are stored for evaluation in an available control device. These values which represent actual values can then be compared in the control device concerned with predetermined target temperature values corresponding to the respective laundry type and/or the respective state of loading of the laundry drum.

The object stated above is achieved according to the invention secondly in a household appliance for drying damp laundry by means of warm air generated by a heating device, comprising a laundry drum which accommodates the laundry and can be driven by a motor which, together with the said heating device, can be controlled by a control device, and comprising at least one measuring device, which measures at least one dampness value or a measured value of the laundry to be dried corresponding thereto for analysis and termination of the respective drying process by the control device, in that a temperature measuring device is additionally provided, by which a temperature variable (21) which is determined during drying of the laundry only when or after a predetermined dampness value (20) or a measured value corresponding thereto is reached, and which corresponds to the respective laundry type and/or the respective state of loading of the laundry drum can be analyzed by the control device (4) for the targeted termination of the drying.

This brings with it the advantage that it can be managed at particularly low cost in order to be able in the household appliance executing the method according to the invention to control the drying of damp laundry such that over- or underdrying as a function of the laundry type and quantity is avoided and that the respective drying process can be terminated at the correct time desired in each case, i.e. when the laundry concerned has been dried in the desired manner. This is achieved in that the mentioned temperature variable is additionally used in correlation with a defined dampness value or a measured value corresponding thereto. In other respects, this prevents in a simple and safe manner the dryer from switching off too early due to an incorrect measurement of the dampness of the laundry, in that the mentioned temperature variable is additionally taken into account as an auxiliary variable.

According to a further useful embodiment of the invention, the respective absolute drying temperature value is to be processed by the control device as a temperature variable. It can in this way advantageously be managed with particularly minimal measuring effort.

According to another useful embodiment of the invention, the gradient of a drying temperature curve given by at least two measured temperature values is to be processed by the control device as a temperature variable. The control device can in this way control a drying process even more accurately as a function of temperature changes. Once a required dampness threshold value of the laundry is reached, the temperature curve rises again briefly, as will be seen in greater detail further below, and only in this area is the gradient of the temperature curve concerned determined as an actual variable which can be compared with a predetermined temperature representing a target variable.

According to a particularly advantageous embodiment of the invention, the temperature variable is derived from exhaust air which emerges from the laundry drum. The temperature measuring device is positioned in particular at the laundry drum outlet, and it functions as a temperature sensor for measuring the exhaust air of the dryer which emerges through an exhaust-air duct. The measured values of the exhaust-air temperature supply the additional information about the state of dryness of the laundry in the dryer.

An exemplary embodiment of the invention will be explained in detail below with the aid of drawings, in which:

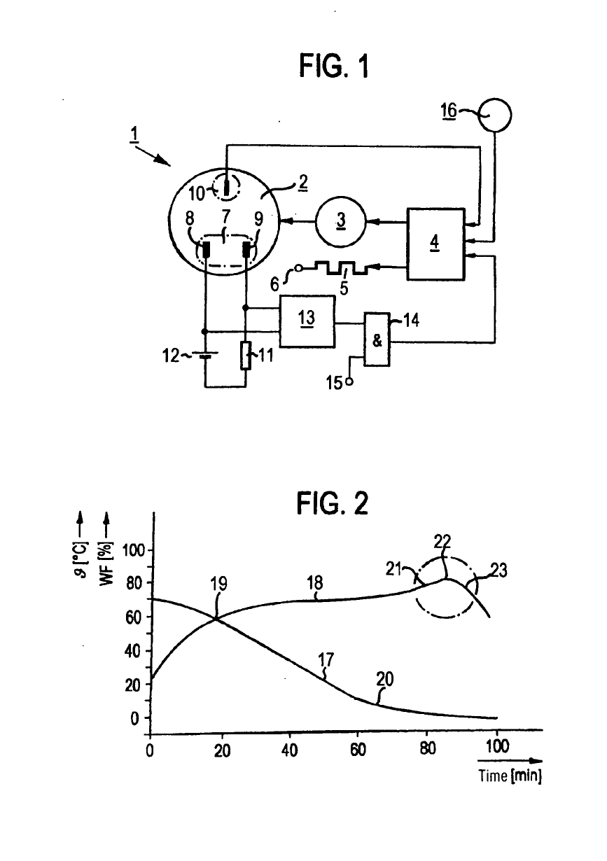

FIG. 1 shows a schematic representation of the basic structure of a household appliance for drying damp laundry;

FIG. 2 shows a diagram of the time-dependent temperature and laundry-dampness curve of an item of laundry in the course of its drying in a household appliance for drying damp laundry.

FIG. 1 shows a schematic representation of a washer-dryer or dryer 1, which essentially comprises a laundry drum 2 for accommodating laundry to be dried respectively, a motor 3 displacing the laundry drum in rotations and a control device 4 controlling said motor, which control device also allows a heating device 5 to be actuated. This heating device 5 is indicated in FIG. 1 as a heating resistor 5, which is connected to its end lying away from the control device 4 to a terminal 6, which is connected for example to the neutral conductor of a mains AC voltage source (not shown). In this case, the control device 4 allows a phase voltage to be fed from the mentioned mains AC voltage source to the end of the heating resistor 5 connected to it, for example via a make contact of a mechanical relay.

With regard to the heating device or the heating resistor 5, it should still be noted here that the air heated thereby is introduced as a warm-air flow into the laundry drum 2 by means of a fan blade (not shown here) also driven by the motor 3. Damp laundry located in the laundry drum 2 is then dried with this warm-air flow. The warm-air flow carrying with it moisture from the laundry to be dried is then discharged from the washer-dryer or dryer 1 as exhaust air.

A resistance-measuring device 7 comprising two electrodes 8, 9 provided at a distance from one another is located in the laundry drum 2. By means of this resistance-measuring device 7, a measured resistance value corresponding to the dampness value of the laundry to be dried and located in the laundry drum 2 is determined. In the case of damp laundry, the resistance, which is to be measured between the two measurement electrodes 8, 9, lies in the order of a few ohms, and in the case of dry laundry, the measured resistance value concerned amounts to as much as several megohms. It should be noted at this point that in principle the dampness value of the laundry respectively located in the laundry drum 2 can also be measured by means of a hygrometer; the arrangement shown in FIG. 1 with the resistance-measuring device 7 is, however, preferably used in washer-dryers or dryers due to its simplicity and robustness.

Also provided in the laundry drum 2 is a temperature sensor 10 which constitutes a temperature-measuring device by means of which, as will be explained further below, for example, the temperature of the exhaust air emerging from the laundry drum 2 is determined.

The resistance-measuring device 7 comprising the two measurement electrodes 8, 9 is connected as per FIG. 1 in series with an ohmic resistor 11 to a DC voltage source 12, which emits a DC voltage of, for example, 1.5V. The resistance-measuring device 7 and the ohmic resistor 11 consequently constitute a voltage divider, to the resistance measuring device 7 of which a measuring device 13 is connected, which in the present case is a voltage-measuring device. This voltage-measuring device measures the voltage from the DC voltage source 12 dropping respectively at the resistance-measuring device 7. This voltage corresponds to the respective dampness value of the laundry to be dried which is located in the laundry drum 2. The voltage-measuring device 13 concerned emits at the output end an output signal corresponding to the respectively measured voltage, for example a corresponding output voltage which is fed to the one input of a comparator unit 14, which at another input is fed a threshold voltage applied to a terminal 15. This comparator unit 14 may be configured such that if the threshold voltage concerned is not exceeded by the output voltage of the voltage-measuring device 13, a binary signal “0” is emitted at the output end for example and that, if the threshold voltage concerned is exceeded by the mentioned output voltage of the voltage-measuring device 13, a binary signal “1” is emitted at the output end. The binary signals “0” and “1” concerned are fed on the input side to the control device 4.

The said control device 4 is also connected at the input end to a program selector 16, by adjustment of which, for example, different drying programs and thus runtimes of the motor 3 and heating times and types of the heating device 5 can be set. By means of the adjustment concerned, the drying of different types of laundry and/or different loading states of the laundry drum 2 can be taken into account and corresponding setpoint values fed to the control device 4 for targeted switching off of the respective drying process. In the control device, a comparison of setpoint value and actual value then takes place between a respectively predetermined setpoint temperature variable and the respectively measured actual temperature value, as will be explained in yet more detail further below.

Now that the essential structure of the washer-dryer or dryer 1 has been illustrated with the aid of FIG. 1, the diagram shown in FIG. 2 will now be discussed in detail. This diagram shows firstly a dampness curve 17 of the relative laundry dampness WF in the laundry drum 2 shown in FIG. 1 and secondly a temperature curve 18 of the temperature θ in ° C. of the exhaust air discharged from the laundry drum 2 as a function of the time in minutes (min). Here, a constant heat output of the heating device 5 is assumed as per FIG. 1.

As can be seen from the diagram as per FIG. 2, the relative laundry dampness WF of the laundry to be dried which is located in the laundry drum 2 as per FIG. 1 is 70%. The temperature θ lies at this point in time at an ambient temperature of, for example, 25° C.

As can be seen from FIG. 2, the relative laundry dampness WF falls according to the dampness curve 17 within about 20 minutes, the temperature θ of the warm air having in the meantime risen to about 60° C., which corresponds to the point of intersection 19 given in FIG. 2 between the dampness curve 17 and the temperature curve 18. Up to this point 19, a reduction in the relative laundry dampness WF of only about 10% has been achieved by a relatively sharp rise in the temperature of about 35° C.

From the aforementioned point of intersection 19, the temperature θ rises until a time of about 80 min only by about 20° C. more, while the relative laundry dampness WF has according to the dampness curve 17 fallen by this time (80 min) to a few percent and is still changing only slightly.

As explained in connection with FIG. 1, the relative laundry dampness WF of the laundry to be dried which is contained in the laundry drum 2 is not measured there directly by a hygrometer but a measured value corresponding to the dampness concerned is determined between the measurement electrodes 8 and 9 of the resistance-measuring device 7. The measured value concerned is in accordance with FIG. 1 a measured voltage value which is determined by means of the voltage-measuring device 13, whose output signal is then compared in the comparator unit 14 with a threshold value and evaluated. The arrangement as shown in FIG. 1 can, as already indicated above, be configured such that the comparator unit 14 emits a binary signal “1” displaying the exceeding of the threshold value concerned by the output signal emitted by the voltage-measuring device 13, for example, at a time when a voltage value is measured by the voltage-measuring device 13, which voltage value corresponds to the relative laundry dampness WF in FIG. 2 in the dampness range 20 specified there—in this dampness range 20, the relative laundry dampness WF amounts, for example, to 10%.

The emission of the aforementioned binary signal “1” by the comparator unit 14 prompts the control device 4 as per FIG. 1 to use the temperature θ determined by the temperature sensor 10 in the exhaust air of the laundry drum 2 for a targeted termination of the drying. Here, either the absolute value of the temperature θ determined by the temperature sensor 10 or the gradient of the temperature curve 18 as per FIG. 2 can be evaluated by the control device 4.

With regard to this temperature curve 18, it has namely been shown that this exhibits a temperature-increase range 21 toward the end of the drying process, i.e. when the moisture remaining in the laundry corresponds to a normal desirable residual moisture. The cause of this has been explained above. This rise 21 therefore marks a time range in which the drying process should be aborted, and this with significantly greater clarity than would be possible by analyzing the laundry dampness 20. The precise stipulation of the time at which, once proof of the rise 21 has been obtained, the drying process is terminated by switching off the heating, is optionally to be determined in a trial run and to be stipulated accordingly. This time is marked in FIG. 2 by the temperature maximum 22 and the subsequent temperature-decrease range 23, during which a cooling down of the dried laundry takes place.

shows when the heat output by the heating device is unchanged.

The necessary temperature evaluation is carried out by the control device 4, which does so by executing a setpoint/actual value comparison between a setpoint temperature set by the program selector 16 according to the respective laundry type and/or the respecting loading state of the laundry drum 2 and the actual temperature determined by the temperature sensor 10. In the simplest case, the temperature rise 21 is established by measuring and evaluating the temperature of the exhaust air in order then to terminate the drying in the dryer in a targeted manner. However, it is also possible, to take into account in the temperature-increase range 21 repeatedly at least two measuring points and based upon these to evaluate the gradient of the temperature curve in the control device 4, in order to terminate the drying in the dryer or washer-dryer 1 in a targeted manner. Where the gradient of the temperature curve is taken into account in the control device 4, a setpoint temperature gradient corresponding to the respective laundry type and/or the respective loading status of the laundry drum 2 can be set in the control device by the program selector 16. Taking into account the respectively determined actual temperature variable when or after a predetermined dampness value or a measurement value corresponding thereto has been reached and including this actual temperature variable value in the mentioned setpoint/actual value comparison consequently makes it possible in a particularly simple but effective way for over- or underdrying of the laundry as a function of the respective laundry type to be avoided.

### LIST OF REFERENCE CHARACTERS

1 Washer-dryer or dryer
2 Laundry drum
3 Motor
4 Control device
5 Heating device, heating resistor
6 Terminal
7 Resistance-measuring device
8 Electrode
9 Electrode
10 Temperature sensor
11 Ohmic resistor
12 DC voltage source
13 Voltage-measuring device
14 Comparator unit
15 Terminal
16 Program selector
17 Dampness curve
18 Temperature curve
19 Point of intersection
20 Dampness range
21 Temperature-increase range
22 Temperature maximum
23 Temperature-decrease range

1-7. (canceled)

8. A method for controlling the drying of damp laundry in a laundry drum of a household appliance, the method comprising:
generating warm air for a drying process; and
terminating the drying process based upon a temperature variable determined when a predetermined dampness value or a measured value of the laundry is reached, the temperature variable corresponding to a respective laundry type or a respective state of loading of the laundry drum.

9. The method of claim 8, wherein the temperature variable comprises an absolute value of the drying temperature.

10. The method of claim 8, wherein the temperature variable comprises a gradient of a drying temperature curve.

11. A household appliance for drying damp laundry comprising:
a heating device that generates warm air;
a laundry drum for accommodating laundry;
a motor for driving the laundry drum;
a measuring device that measures a dampness value or a measured value of the laundry;
a temperature measuring device that determines a temperature variable in response to a predetermined dampness value or a measured value of the laundry is reached; and
a controller for controlling the heating device and the motor, for analyzing the dampness value or the measured value of the laundry, and for terminating drying based upon the temperature variable corresponding to a respective laundry type or a respective state of loading of the laundry drum.

12. The household appliance of claim 11, wherein the temperature variable comprises a respective absolute drying temperature value.

13. The household appliance of claim 11, wherein the temperature variable comprises a gradient of a drying-temperature curve from two measured temperature values.

14. The household appliance of claim 12, wherein the temperature measuring device measures a temperature variable in an exhaust air which emerges from the laundry drum.
